(19) United States
(12) Patent Application Publication
(10) Pub. No.: US 2026/0212053 A1
(43) Pub. Date: Jul. 23, 2026

(54) METHOD AND COMPUTING UNIT FOR DETECTING AN UNAUTHORIZED PHYSICAL ACCESS OF A BUS SYSTEM

(71) Applicant: Robert Bosch GmbH, Stuttgart (DE)

(72) Inventors: Arthur Mutter, Neuhausen (DE); Eugen Becker, Ludwigsburg (DE)

(21) Appl. No.: 19/138,904

(22) PCT Filed: Dec. 19, 2023
(86) PCT No.: PCT/EP2023/086608

§ 371 Date: Jul. 31, 2025

(30) Foreign Application Priority Data
Dec. 21, 2022 (DE) 10 2022 214 195.4

(51) Int. Cl. G06F 21/85; G06F 21/55; H04L 12/40

(52) U.S. Cl. CPC G06F 21/85; G06F 21/55; H04L 12/40026

(57) ABSTRACT

A method for identifying unauthorized physical access to a bus system. Bus participants generate a voltage signal on the bus lines from a transmission signal from a bus protocol controller and determine a reception signal for the bus protocol controller from the voltage signal. The method includes: detecting the voltage signal on the bus lines; determining a sampling period based on a signal received or output by the bus protocol controller; forming a sampling pattern based on the detected voltage signal, and evaluating, at sampling time points within the sampling period, whether or o not the detected voltage signal is above a specific threshold voltage; comparing the sampling pattern with at least one reference pattern; and determining that possible unauthorized physical access is present if the sampling pattern does not match the at least one reference pattern within a tolerance.

### FIELD

The present invention relates to a method for identifying unauthorized physical access to a bus system and to a computing unit for carrying out said method.

### BACKGROUND INFORMATION

Programmable control units are used in machines and motor vehicles to control them or their components. For example, a motor vehicle may contain control units for engine control, for the braking system, etc. The control units comprise a microcontroller or processor with one or, typically, more processor cores that execute programs stored in a memory, in order to achieve the functions of the control unit.

The control units can be connected to one another and to other devices, such as sensors, via a bus. For example, the CAN (controller area network) bus, which is a bus based on differential voltages that transmits data or messages via two bus lines, is widely used; bus lines and bus participants together form a bus system.

Germany Patent Application Nos. DE 10 2017 208 547 A1 and DE 10 2018 208 118 A1 describe methods according to which characteristics, such as signal edges, of a transmission of a message via a network are evaluated, wherein the origin of the message is determined, or the message is authenticated, on the basis of the characteristics. Germany Patent Application Ns. DE 10 2020 213 893 A1 and DE 10 2020 214 099 A1 describe methods of how attacks can be identified by evaluating reflections on a CAN bus.

### SUMMARY

According to the present invention, a method for identifying unauthorized physical access to a bus system as well as a computing unit for carrying out said method are provided. Advantageous example embodiments of the present invention are disclosed herein.

In a bus system in which data are transmitted in message frames according to a bus specification as a voltage signal on bus lines, wherein bus participants are configured to generate the voltage signal on the bus lines from a transmission signal and to determine a reception signal from the voltage signal on the bus lines, the present invention makes use of the measure of identifying unauthorized physical access by evaluating, at sampling time points within a sampling period, whether or not a sampling pattern of the voltage signal matches at least one reference pattern. The sampling period is determined based on at least one signal received or output by a bus protocol controller. Accordingly, the sampling period or its starting time point is in particular not determined from the voltage signal or the voltage on the bus lines. The sampling period can thus be determined independently of the voltage signal to be evaluated for determining the sampling pattern, so that correlations between the sampling period and the voltage signal, which could lead to physical access not being identified, are avoided. In particular, this also makes a wider range of suitable sampling periods possible (in comparison to, for example, the possibility of starting a sampling period with a level transition in the voltage signal).

The at least one signal received or output by the bus protocol controller comprises in particular the transmission signal, which is usually transmitted by the bus protocol controller to the bus transceiver, and the reception signal, which takes the reverse path. Furthermore, the at least one signal comprises one or more state or status signals, which are output by the bus protocol controller and in particular contain logical information about a message frame currently being processed by the bus protocol controller.

The bus system may, for example, be a bus system based on differential voltages, in particular a CAN bus system (CAN: controller area network; ISO 11898-1, 11898-2; Bosch, CAN Specification, Version 2.0, 1991), i.e., the voltage signal is a differential voltage signal.

In one example embodiment of the present invention, the sampling period is determined taking into account the format or structure of message frames according to the bus specification, wherein a message frame starting time point and/or a message frame period is in particular determined or derived. The sampling period may in this case be defined according to a predetermined position relative to the message frame starting time point and/or within the message frame period. The bus protocol controller (such as a CAN controller) involved knows the period of time over which a message frame extends and, for example, also when specific bit sequences, in which an edge occurs in the voltage signal, typically occur and this can in particular be signaled by the aforementioned one or more status signals so that the definition is made in particular based on one or more state or status signals included in the at least one signal. This embodiment makes it possible to select suitable sampling periods in which level transitions occur in the voltage signal, leading to sampling patterns that are characteristic of the bus system.

A computing unit according to the present invention, e.g., a control unit of a motor vehicle, is connected or connectable to a bus system and is configured, in particular programmatically, to carry out a method according to the present invention.

The implementation of a method according to the present invention or dividing the method (e.g., see below, with respect to the detection module and/or the measurement time point module and/or the comparison module) of the present invention in the form of a computer program or computer program product with program code for carrying out all method steps is advantageous since this incurs particularly low costs, in particular if an executing control unit is also used for further tasks and is therefore present anyway. Finally, a machine-readable storage medium is provided with a computer program as described above stored thereon. Suitable storage media or data carriers for providing the computer program are, in particular, magnetic, optical, and electric storage media, such as hard disks, flash memory, EEPROMS, DVDs, and others. It is also possible to download a program via computer networks (Internet, intranet, etc.). Such a download can be wired or wireless (e.g., via a WLAN network or a 3G, 4G, 5G 6G connection, etc.).

Further advantages and example embodiments of the present invention can be found in the description herein and the figures.

The present invention is shown schematically in the figures on the basis of exemplary embodiments and is described below with reference to the figures.

### BRIEF DESCRIPTION OF THE DRAWINGS

FIG. 1 shows an exemplary structure of a bus system, according to the present invention.

FIG. 2 shows an exemplary arrangement, which can be used to carry out the method for identifying unauthorized physical access to a bus system, according to an example embodiment of the present invention.

FIGS. 3A, 3B, and 3C show different ways of determining sampling periods in a bus system, e.g., a CAN bus system.

FIG. 4 shows a flowchart according to an exemplary embodiment of the present invention.

### DETAILED DESCRIPTION OF EXAMPLE EMBODIMENTS

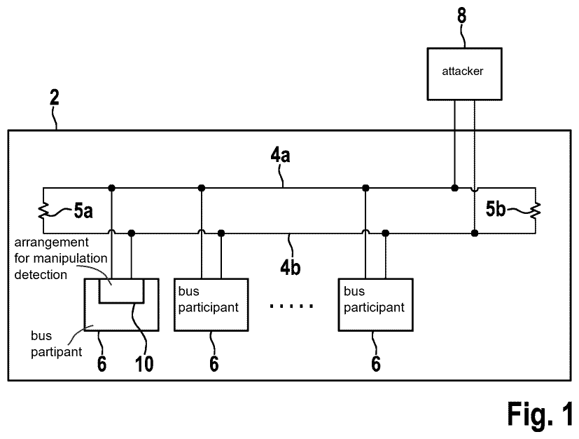

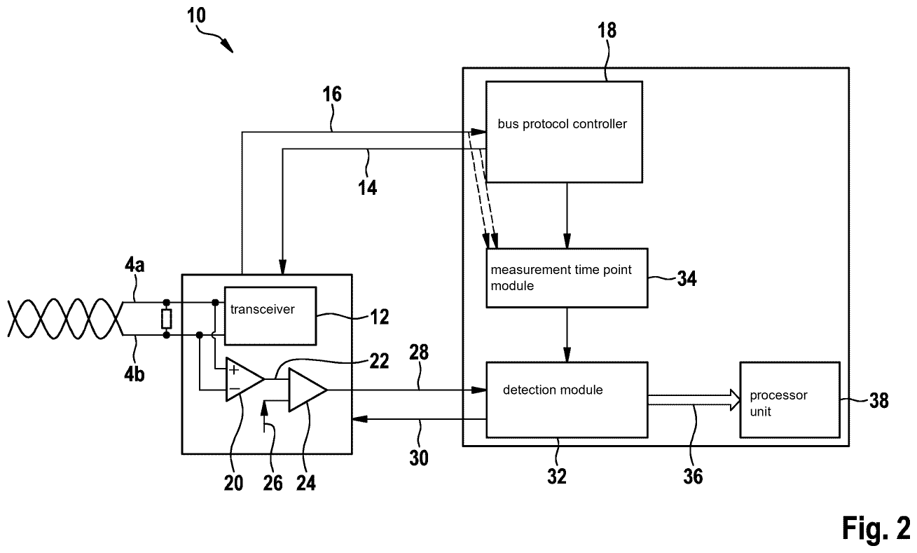

FIG. 1 shows an exemplary structure of a bus system 2, in particular a bus system based on differential voltage signals, such as a CAN bus system, and an attacker 8. The bus system 2 comprises, on the one hand, lines 4a, 4b, via which the voltage signals are transmitted and which are connected to one another via terminating resistors 5a, 5b, which represent the central impedance of the bus system, and, on the other hand, multiple bus participants 6, which are connected to the two bus lines 4a, 4b in order to communicate with one another via the bus. For this purpose, the bus participants use differential voltages between the two bus lines, which voltages are generated from transmission signals (TxD) by means of transceivers and read in order to receive reception signals (RxD). Examples of bus participants 6 are control units of a motor vehicle or of a machine that transmit control data, or sensors that transmit sensor data, for example to control units. One of the bus participants comprises an arrangement 10 for manipulation identification, which is explained in more detail in connection with FIG. 2; of course, the other bus participants may also comprise such an arrangement. The bus participant comprising the arrangement 10 for manipulation identification may be a computing unit (e.g., control unit) that also performs other tasks in the device or machine in which the bus system is used, or a separate computing unit that is used exclusively for manipulation identification. In this application, the term “bus participant” refers to regular bus participants who are permitted to access the bus, as opposed to an “attacker” who accesses the bus without authorization.

The attacker 8, for example a device that also has a transceiver or at least a transmitter or receiver, for example a so-called OBD connector, has physical access to the bus system and can thus establish an electrical connection to the lines 4a, 4b (i.e., gain physical access to the bus system). The attacker 8 is thus able to listen to messages transmitted via the bus or to read the corresponding voltage signals and/or to transmit messages themselves or to generate corresponding voltage signals.

FIG. 2 shows an exemplary arrangement 10, which can be used to carry out the method for identifying unauthorized physical access to a bus system (e.g., a CAN bus system). The arrangement can be realized in or comprised by a bus participant, e.g., a control unit or a computing unit.

The arrangement 10 is connected to the bus lines 4a, 4b. In this case, a transceiver 12 connected to the bus lines is provided and is configured to generate electrical voltage signals on the bus lines according to the specification of the particular bus and based on transmission signals 14 (typically referred to as TxD for short) and to determine reception signals 16 (typically referred to as RxD for short) from electrical voltage signals present on the bus lines. A bus protocol controller or bus protocol module 18 (for example, a CAN controller) is provided, which is configured to convert data to be transmitted (i.e., data that the bus participant wishes to transmit) into corresponding transmission signals 14 and to convert reception signals 16 into corresponding received data. Data to be transmitted are, for example, data that the bus participant wishes to transmit, and received data are, for example, data that are processed by the bus participant. In this respect, the arrangement corresponds to the known structure and the known functioning of a bus transmitting/receiving device provided in bus participants.

Furthermore, a comparator, also connected to the bus lines and referred to as voltage signal comparator 20, may be provided, which determines the differential voltage between the bus lines, i.e., which generates the voltage signal 22 or differential voltage signal used in the bus system for data communication. A similar comparator is typically used in the transceiver to obtain the differential voltage signal. Accordingly, it is also conceivable to obtain the voltage signal 22 from the transceiver instead of from a separate voltage signal comparator 20. A separate voltage signal comparator 20 is useful since its threshold voltage can be selected or configured independently (in particular of the transceiver). In other bus systems that do not use a differential voltage signal for data communication, a corresponding suitable voltage signal (i.e., a voltage signal in which voltage fluctuations occur that are characteristic of the bus system) can be used and evaluated as described below.

The voltage signal 22 is compared with a threshold voltage 26 by means of a comparator, which is referred to as a measurement signal comparator 24. A measurement signal 28 that indicates whether the voltage signal 22 is above or not above (or above or below) the threshold voltage 26 is thus obtained at the output of the measurement signal comparator 24. The threshold voltage 26 may be configurable or adjustable via a control channel 30, wherein it is also possible for the control channel 30 to comprise a conductor, which is connected to the corresponding input of the measurement signal comparator 24 and to which the threshold voltage 26 is applied, or which is connected to a voltage control element connected to the corresponding input of the measurement signal comparator 24. The measurement signal comparator 24 and, optionally, the voltage signal comparator 20 may be provided as discrete elements in addition to the transceiver 12 or may be integrated together with the transceiver 12 in a chip.

The measurement signal 28 is detected by a detection module 32, which is configured to sample the measurement signal 28 at sampling time points and to determine bit patterns based on the sampling, wherein each bit or position of a bit pattern corresponds to a sampling time point. The sampling time points may, for example, be regularly spaced, i.e., lie on a time grid corresponding to a sampling frequency. The bits or positions are assigned a first value (e.g., 0) if the measurement signal 28 indicates that the voltage signal 22 is above the threshold voltage 26 at the corresponding sampling time point, and are assigned a second value (e.g., 1) different from the first value if the measurement signal 28 indicates that the voltage signal 22 is not above (or is below) the threshold voltage 26 at the corresponding sampling time point.

A bit pattern is determined based on the sampling time points that lie within a specifiable sampling period. That is to say, a sampling period is specified to the detection module 32, which determines a bit pattern associated with the sampling period, based on the sampling time points that lie within the specified sampling period. The specification of sampling periods may, for example, be carried out by specifying (by means of suitable signals) a starting time point and a duration or an end time point. A fixed duration, e.g., a specific number of sampling time points, may also be used.

The detection module 32 is configured to transmit data 36, i.e., in particular the determined bit patterns, to a processor unit 38, which evaluates the bit patterns.

The detection module 32 may furthermore be configured to configure or adjust the threshold voltage 26 via the control channel 30.

The specification of sampling periods may in particular be carried out by a measurement time point module 34. The measurement time point module 34 may (i.e., is configured to) evaluate state signals from the bus protocol controller 18 and/or the transmission signal 14 and/or the reception signal 16 in order to determine sampling periods based thereon.

The bus protocol controller may be in transmit or receive mode, for example. The bus protocol controller is precisely synchronized to the particular message frame (that it transmits or receives). Bit boundaries, sampling time points, specific positions within the message frame can thus be determined or tapped as individual signals, and corresponding state signals can be provided. The state signals indicate specific (temporal) positions relative to the message frame starting time point and/or within the message frame period. The state signals used to determine or define sampling periods can be selected and/or configured in the measurement time point module. Sampling periods may, for example, be started and/or stopped in temporal relation to the selected or configured state signals. For example, the occurrence of a specific state signal within a message frame can be used as the starting time point of a sampling period. The end time point of this sampling period may then, for example, be a specific temporal length of a specified length after the starting time point or may be determined by a further specific state signal.

When determining sampling periods or when defining which periods are to be used as sampling periods, the structure of messages according to the particular bus specification can be taken into account, i.e., for example, specific periods within messages or message frames (message packets) are selected, such as periods that include specific level transitions (edges) in the voltage signal. The state signals can be used to identify when the corresponding sampling period occurs.

In particular, the sampling periods are selected or determined such that they result in bit patterns that are characteristic of the bus system, i.e., that may change if the physical structure of the bus system is changed (i.e., the electrical properties, e.g., capacitance, impedance, inductance, are changed), for example because an attacker establishes an electrical connection to the bus lines. Such changes can be identified by comparing currently determined bit patterns with corresponding reference patterns that were determined as bit patterns in an unchanged or original structure or state. This comparison may, for example, be carried out by the processor unit 38 (or a suitable comparison module), which stores reference patterns for this purpose. If it is determined during the comparison that the bit pattern corresponds to the reference pattern, it is assumed that no attacker is physically connected to the bus system. On the other hand, if it is determined during the comparison that the bit pattern does not correspond to the reference pattern, it is assumed that an attacker is possibly physically connected to the bus system (“possibly” or “potentially” since the change in the bit pattern could also be caused by a malfunction of the bus system).

It is possible that the specification of sampling periods by the measurement time point module to the detection module is carried out through a signal voltage which has a first level (e.g., high) within sampling periods and a second level (e.g., low) outside sampling periods.

It may be the case that sampling periods of different types, i.e., with which different bit patterns or reference patterns are associated, are specified. In this case, it may be the case that the measurement time point module 34 transmits a corresponding identifier, which indicates which type is present, to the detection module 32 and from there to the processor unit 38 (or a unit referred to as a comparison module, which carries out the comparison of current bit patterns with reference patterns) or directly to the processor unit 38 (or a unit which carries out the comparison of current bit patterns with reference patterns). Alternatively, in this case, it may be the case that the processor unit 38 (or the comparison module) compares received current bit patterns with all reference patterns or compares them sequentially with the multiple reference patterns until a match is found or it is determined that none of the reference patterns matches the current bit pattern.

Since minor variations in the bus system, e.g., fluctuations in a supply voltage, can lead to changes in the bit pattern without a physical connection by another device being present, the comparison can check for correspondence within a certain tolerance. For example, a tolerance can be given in the form of a maximum number of bits or positions by which the current bit pattern may differ from the reference pattern. Alternatively or additionally, a comparison can be carried out with multiple reference patterns, which correspond to minor variations, instead of a single reference pattern. For example, a given reference pattern may be shifted by one bit or one position in order to determine one or two further reference patterns, or reference patterns may be determined during a longer operating period of the bus system, assuming that slight variations occur during the operating period and that corresponding possible different reference patterns can be determined in the process.

In general, a currently determined bit pattern is compared with one or more reference patterns and, if the currently determined bit pattern does not match any reference pattern or does not match any reference pattern within a tolerance, possible unauthorized physical access to the bus system is assumed.

The detection module, the measurement time point module, and the comparison module (or processor unit) or their functionalities can be implemented by hardware and/or software modules. For this purpose, it is also possible to use a generic module, such as a generic timer module as described in EP 2 553 540 A1, for example.

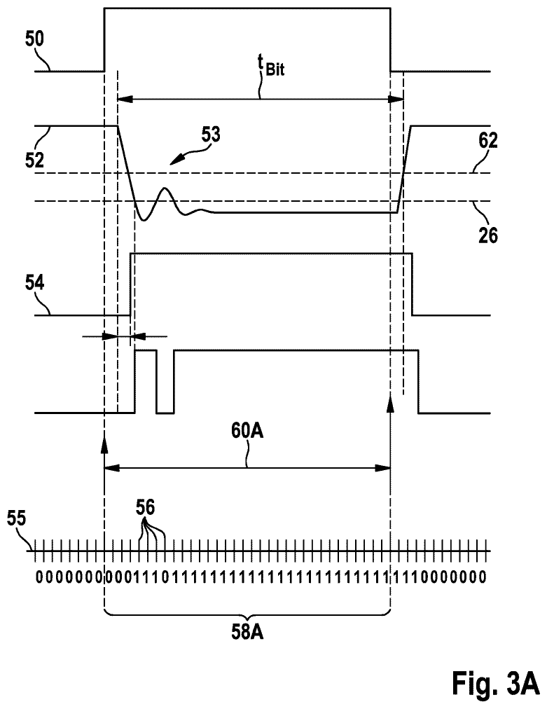

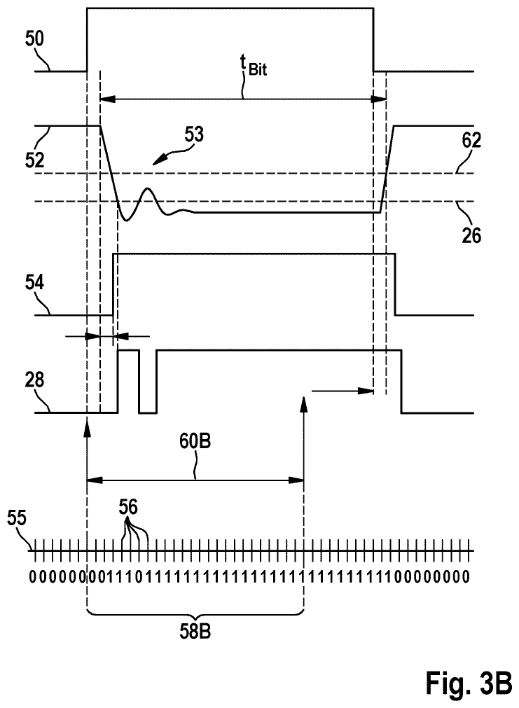

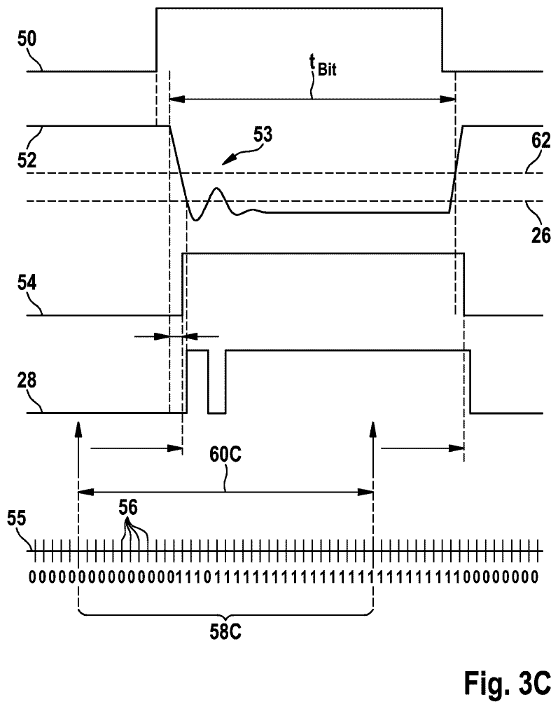

FIGS. 3A, 3B, and 3C show different ways of selecting sampling periods in a bus system, i.e., for example, a CAN bus system, and of obtaining corresponding different sampling patterns.

Shown in each case are a transmission signal 50, an associated (differential) voltage signal 52 applied to the bus lines, a corresponding reception signal 54, a measurement signal 28, a time grid 55 with sampling time points, and a sampling pattern 58A, 58B, 58C, which was determined for a sampling period 60A, 60B, 60C. For each signal, the voltage is plotted against time (which runs from left to right in the figures).

The transmission signal 50 corresponds to the transmission of a so-called recessive bit (logical 1), which corresponds to the (differential) voltage signal 52 on the bus lines. The voltage signal 52 is typically slightly delayed in comparison to the transmission signal 50 (e.g., due to the time delay in the transceiver in order to generate the necessary voltages).

Initially, there is a relatively high differential voltage (at least 2 V in the CAN bus, so-called dominant state), which then transitions via a falling edge into a low differential voltage (0 V in the CAN bus, so-called recessive state), before subsequently transitioning back to the high differential voltage via a rising edge. Such a level sequence is used in the CAN bus to transmit a bit that has the logical value 1, if the time span between the falling and rising edge is a time span t_{bit} predetermined according to the CAN bus system specification.

However, the physical layer, i.e., the bus lines 4a, 4b together with the bus participants 6, has electrical properties, in particular inductances and capacitances, which disturb the idealized differential voltage curve. This leads to disturbances such as changes in the steepness of the edges, reflections, oscillations in the voltage curve and the like. These disturbances depend on the specific realization of the physical layer, i.e., on the design of an actual bus system (e.g., on the length of the lines, on the number of participants and where they are connected to the lines, on the electrical properties of the participants'transceivers, etc.). The actual differential voltage curve (voltage signal 52) is shown in the figures. Here, after the falling edge, oscillations 53 (also referred to as “ringing”) occur in the differential voltage.

Since the disturbances depend on the design of the bus system, they are characteristic of the particular specific bus system. If a further participant or, as in FIG. 1, an attacker 8 is connected to the bus system, this leads to a change in the disturbances so that a possible manipulation attempt or possible unauthorized access to the physical layer can be identified.

The reception signal 54 is generated from the reception signal 52 by the transceiver (e.g., by means of a comparator in the transceiver) based on an identification threshold 62, which can be specified in particular by the bus specification. Typically, the reception signal 54 is slightly delayed in comparison to the voltage signal 52.

The measurement signal 28 is determined from the voltage signal 52 by comparison with the threshold voltage 26, for example as described in connection with FIG. 2 by means of a measurement signal comparator 24. The measurement signal 28 indicates whether the voltage signal 52 is above or not above (or above or below) the threshold voltage 26. For example, the measurement signal 28 has a low level in the first case (voltage signal 52 above threshold voltage 26) and a high level in the second case (voltage signal 52 below threshold voltage 26).

These voltage or signal curves are the same in the three FIGS. 3A, 3B, 3C. Different sampling patterns result from different sampling periods.

The sampling patterns 58A, 58B, 58C (here binary sampling patterns or bit patterns) are obtained from the measurement signal 28, wherein the measurement signal 28 is sampled or evaluated at sampling time points 56 (or measurement time points) that lie within a particular sampling period. In the example shown, the sampling pattern is assigned a value of 1 (first value) if the measurement signal 28 has the high level (voltage signal 52 is above the threshold voltage 26) at the corresponding sampling time point, and is assigned a value of 0 (second value) if the measurement signal 28 has the low level (voltage signal 52 is not above or is below the threshold voltage 26) at the corresponding sampling time point.

The sampling time points 56 used are the time points of the time grid 55 (which has evenly spaced time points) that lie within the particular sampling period 60A, 60B, 60C. The sampling periods are determined (temporally) relative to the transmission signal 50 and/or reception signal 54.

In FIG. 3A, the sampling period 60A extends from the rising level transition (rising edge) from dominant to recessive in the transmission signal 50 (starting time point) to the falling level transition (falling edge) from dominant to recessive in the transmission signal 50 (end time point). The positions of the sampling pattern 58A correspond to the sampling time points 56 in the sampling period 60A, wherein it can be seen that the sampling pattern changes multiple times between 0 and 1 according to the oscillations 53, which characterizes the oscillations and, accordingly, the bus system. For example, a bit length t_{bit} of 2 μs and a sampling rate of 80 Mhz result in: 2 μs/12.5 ns=160 samples (number of positions of the sampling pattern), which corresponds to 5 transfers of 32-bit width into a memory. For example, a bit length t_{bit} of 2 μs and a sampling rate of 160 Mhz result in: 2 μs/6.25 ns=320 samples, which corresponds to 10 transfers of 32-bit width into a memory.

In FIG. 3B, the sampling period 60B extends from the rising level transition from dominant to recessive in the transmission signal 50 (starting time point) to a bit detection time point (end time point) at which the protocol module evaluates the value of the received reception signal. The bit detection time point (so-called sample point) is specified in particular by the bus specification and denotes a time point at which the voltage signal 22 is assumed to be stable (for example, a specific time span, approximately 1.7 μs with a bit time length of t_{bit} of 2 μs, after the reception signal indicates that the voltage signal falls below the detection threshold 62), which is thus located after the oscillations 53 and is therefore suitable for evaluating the voltage signal. The positions of the sampling pattern 58B correspond to the sampling time points 56 in the sampling period 60B. For example, a bit length t_{bit} of 2 μs, a bit detection time point at 1.7 μs, and a sampling rate of 80 Mhz result in: 1.7 μs/12.5 ns=136 samples, which corresponds to 4 to 5 transfers of 32-bit width into a memory. For example, a bit length t_{bit} of 2 μs, a bit detection time point at 1.7 μs, and a sampling rate of 160 Mhz result in: 1.7 μs/6.25 ns=272 samples, which corresponds to eight to nine transfers of 32-bit width into a memory. This means that less data need to be recorded.

In FIG. 3C, the sampling period 60C extends from a bit detection time point (starting time point) of a previously transmitted dominant bit (shown incompletely) to the bit detection time point (end time point) of the currently transmitted recessive bit (shown completely). The positions of the sampling pattern 58C correspond to the sampling time points 56 in the sampling period 60C. The temporal length of the sampling period 60C is equal to the temporal length of the sampling period 60A of FIG. 3A so that the samples mentioned above as examples (number of positions of the sampling pattern) again result here. The embodiment of FIG. 3C takes advantage of the fact that the structure of message frames in which messages are transmitted and the frequency at which they are transmitted are known in the bus system or according to the bus specification. Corresponding start and end time points for the sampling period can therefore also be derived from the reception signal, i.e., the embodiment of FIG. 3C may also be implemented by a receiving bus participant (and also by the transmitting bus participant).

In FIGS. 3A, 3B, 3C, the sampling period is in each case selected such that oscillations after a level transition, which lead to characteristic sampling patterns, lie within the sampling period. In the embodiment of FIG. 3A, this can be derived directly from the transmission signal, i.e., it is known from the transmission signal when a level transition from dominant to recessive occurs.

For example, properties of the voltage signal or its temporal sequence and of the structure of message frames that are from the bus specification can be used in the embodiments of FIGS. 3B and 3C. The known temporal sequence (or timing) of the voltage signal includes, in particular, a specification of the temporal length of bits and the bit detection time points. From the known structure of message frames from the reception signal (or transmission signal or in the bus protocol controller), it can be concluded when periods suitable for pattern periods occur, e.g., at which bit sequences within the message frame a change in the value of the bits occurs, so that the corresponding voltage signal includes a falling edge in the corresponding period. The structure of message frames corresponds in particular to a format specified in the bus specification. A message frame (or a message) contains multiple parts or fields: in addition to the actual data to be transmitted (data field), typically additional fields or frame data, the structure of which is defined in the bus specification, e.g., identifier data (e.g., receiver identifier, transmitter identifier or, in the CAN bus, priority identifier or arbitration identifier) and/or control or administration data (e.g., which type of message frame, frame start data, frame end data, format data or which version of the bus implementation, for example, Classical CAN, CAN FD, CAN XL in the CAN bus) and/or error correction data. These frame data, whose format is known, can be used to determine suitable measurement periods for which a non-trivial sampling pattern can be determined. That is to say, measurement periods can be determined such that they include a suitable level transition that leads to a sampling pattern that is characteristic of the bus system.

For example, the control or administration data may include consecutive bits that always have the same values, i.e., that always include a suitable level transition or a suitable sampling period. The temporal position of such transitions can also be derived from the reception signal.

With respect to a CAN bus system (for example, according to the standards ISO 11898-1, 11898-2), this could be carried out as explained below.

Since the entire CAN message is transmitted at the same bit rate with Classical CAN, the exact position for the start of the sampling period is not of great importance. It should merely be after the arbitration field. It is important to detect the transition from dominant to recessive. For example, the sampling period is started at the dominant bit and, if the next bit is dominant again, the sampling period can be started again. The transition from FDF to DLC bit 3 can be used as the first position for the start of the sampling period (for the naming of the bits, see the standards mentioned above). If DLC bit 3 is not transmitted recessively, the measurement window is started again at DLC bit 3, and so on.

CAN FD includes two cases:
1) Base frame format: The edge from dominant to recessive is present at the transition from the IDE to the FDF bit. Since these format bits are in the CAN FD frame, this edge change always occurs. The sampling period starts, for example, in the IDE bit or at the bit boundary to the FDF bit.
2) Extended frame format: The edge from dominant to recessive is present at the transition from the RRS to the FDF bit. Since these are format bits in the CAN FD frame, this edge change always occurs. The sampling period starts in the RRS bit or at the bit boundary to the FDF bit.

In CAN XL, the same bits can be used for the sampling period as in the CAN FD base frame format. In this case, identical CAN identifiers should not be used, since arbitration will still take place during the FDF bit otherwise (reason: in CAN XL, the FDF bit is part of the arbitration field).

Alternatively or additionally, a specific test frame containing data with desired bit transitions (e.g., logical 0 to logical 1, correspondingly dominant to recessive) in the data field can be sent to carry out the method. The position of the sampling periods could be configured (e.g., from bit N to N+1) in the measurement time point module as described above.

Since the oscillations after a level transition may depend on the position at which the voltage signal is generated on the bus lines, i.e., by which bus participant, it may be the case, in particular on the receiver side (e.g., when using the reception signal), to associate one or more specific reference patterns with the identifier data and/or to provide only one sampling period if specific identifier data are identified.

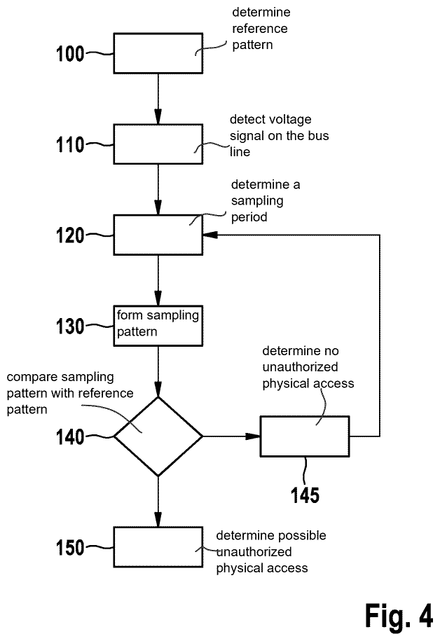

FIG. 4 shows a flowchart according to an exemplary embodiment.

In optional step 100, at least one reference pattern is determined. The procedure is according to the following steps 110, 120, and 130, with the difference that it is assumed that there is no physical access by another device (which is not normally comprised in the bus system). The reference pattern is thus determined as a sampling pattern during a time span in which there is no physical access by another device. As explained in connection with FIG. 2, multiple reference patterns may also be determined. Step 100 may, for example, be carried out as part of an initial installation and/or configuration. Step 100 may also be carried out if the threshold voltage has been changed and/or if changes occur in the bus system, e.g., when a new bus participant is connected.

In step 110, the voltage signal on the bus lines is detected, e.g., as a differential voltage signal between voltages applied to the bus lines.

In step 120, a sampling period is determined based on at least one signal received or output by the bus protocol controller, such as the transmission signal and/or the reception signal and/or a state signal.

In step 130, a sampling pattern is formed based on the detected voltage signal, wherein it is evaluated, at sampling time points within the sampling period, whether or not the detected voltage signal is above a specific threshold voltage.

In step 140, the sampling pattern is compared with at least one reference pattern. If the sampling pattern matches at least one reference pattern or matches it within a tolerance, it can be determined in step 145 that there is no possible unauthorized physical access, and the method can be carried out again starting from step 110 (for a further sampling period).

On the other hand, if it is determined during the comparison that the sampling pattern does not match any reference pattern or does not match any reference pattern within a tolerance, it is determined in step 150 that there is possible unauthorized physical access. In this case, appropriate measures can be taken, such as sending a notification, which indicates the possible unauthorized physical access, to the bus participants or an external body. In response to such a notification, bus participants could, for example, switch to a secured mode in which only limited functions are carried out and/or messages on the bus system are regarded as untrustworthy.

1-15. (canceled)

16. A method for identifying unauthorized physical access to a bus system, in which data are transmitted in message frames according to a bus specification as a voltage signal on bus lines, wherein bus participants are configured to generate the voltage signal on the bus lines from a transmission signal from a bus protocol controller and to determine a reception signal for the bus protocol controller from the voltage signal on the bus lines, the method comprising the following steps:
detecting the voltage signal on the bus lines;
determining a sampling period based on at least one signal received or output by the bus protocol controller;
forming a sampling pattern based on the detected voltage signal, wherein it is evaluated, at sampling time points within the sampling period, whether or not the detected voltage signal is above a specific threshold voltage;
comparing the sampling pattern with at least one reference pattern; and
determining that possible unauthorized physical access is present when it is determined during the comparison that the sampling pattern does not match the at least one reference pattern or does not match it within a tolerance.

17. The method according to claim 16, wherein the sampling period is determined taking into account the format or structure of message frames according to the bus specification; wherein a message frame starting time point and/or a message frame period is determined, wherein the sampling period is defined according to a predetermined position relative to the message frame starting time point and/or within the message frame period.

18. The method according to claim 17, wherein the predetermined position relative to the message frame starting time point and/or within the message frame period is defined according to the bus specification as a temporally relative position and/or as a relative position based on fields contained in the message frame.

19. The method according to claim 16, wherein, when determining the sampling period, a starting time point of the sampling period is determined as a transition in the transmission signal which results in a level transition in the voltage signal.

20. The method according to claim 19, wherein the starting time point of the sampling period s determined at a specified temporal distance from a transition in the transmission signal and/or reception signal.

21. The method according to claim 16, wherein the sampling period has a specified temporal length, and/or an end time point of the sampling period is determined when determining the sampling period.

22. The method according to claim 21, wherein the end time point of the sampling period is determined at a specified temporal distance from a transition in the transmission signal and/or reception signal.

23. The method according to claim 16, wherein the sampling pattern is a binary sampling pattern whose positions correspond to the sampling time points, wherein a first value is assigned to the positions whenever the detected voltage at the corresponding sampling time point is above the threshold voltage, and a second value is assigned to the positions whenever the detected voltage at the corresponding sampling time point is not above the threshold voltage, and wherein, when the tolerance is taken into account when checking for correspondence between the sampling pattern and the at least one reference pattern, the tolerance is given as a maximum number of positions at which a deviation may exist.

24. The method according to claim 16, wherein the at least one reference pattern is determined as a sampling pattern in a state of the bus system in which there is no physical access to it by another device.

25. The method according to claim 16, further comprising determining that no unauthorized physical access is present when it is determined during the comparison that the sampling pattern matches one of the at least one reference pattern or matches it within a tolerance.

26. A computing unit connected or connectable to a bus system and configured to identify unauthorized physical access to a bus system, in which data are transmitted in message frames according to a bus specification as a voltage signal on bus lines, wherein bus participants are configured to generate the voltage signal on the bus lines from a transmission signal from a bus protocol controller and to determine a reception signal for the bus protocol controller from the voltage signal on the bus lines, the computing unit configured to perform the following steps:
detecting the voltage signal on the bus lines;
determining a sampling period based on at least one signal received or output by the bus protocol controller;
forming a sampling pattern based on the detected voltage signal, wherein it is evaluated, at sampling time points within the sampling period, whether or not the detected voltage signal is above a specific threshold voltage;
comparing the sampling pattern with at least one reference pattern; and
determining that possible unauthorized physical access is present when it is determined during the comparison that the sampling pattern does not match the at least one reference pattern or does not match it within a tolerance.

27. The computing unit according to claim 26, wherein the computer unit comprises:
a measurement signal comparator configured to compare the detected voltage signal with the threshold voltage in order to determine a measurement signal indicating whether or not the detected voltage signal is above the threshold voltage; and
a voltage signal comparator connected or connectable to the bus lines and configured to generate the voltage signal.

28. The computing unit according to claim 27, further comprising a detection module configured to determine the sampling pattern based on the measurement signal.

29. The computing unit according to claim 26, comprising a measurement time point module configured to determine the sampling period based on the transmission signal and/or the reception signal.

30. The computing unit according to claim 26, comprising a comparison module configured to compare the sampling pattern with the at least one reference pattern and to determine whether the sampling pattern does not match any of the at least one reference pattern or does not match any of the at least one reference pattern within a tolerance.
